(19) United States
(12) Patent Application Publication
(10) Pub. No.: US 2021/0366066 A1
(43) Pub. Date: Nov. 25, 2021

(54) METHOD AND SYSTEM FOR SCHEDULING A VIRTUAL CLASS

(71) Applicant: KellynKai Corporation, Santa Clara, CA (US)

(72) Inventors: John Gareth Davies, Sunnyvale, CA (US); Yuqi Shi, Santa Clara, CA (US)

(21) Appl. No.: 16/880,397

(22) Filed: May 21, 2020

(51) Int. Cl. G06Q 50/20; G06Q 10/10; G06Q 10/06; G06Q 30/02; G09B 5/14; G09B 5/02

(52) U.S. Cl. CPC G06Q 50/205; G06Q 10/1093; G09B 5/02; G06Q 30/0284; G09B 5/14; G06Q 10/063112

(57) ABSTRACT

A method and a system for matching a student with a tutor for a virtual class are presented. Candidate tutors for the virtual class are identified in real-time based on a student's preferences and desired class times. The desired class time may be “now” or “immediately.” Once a match is made, the virtual class proceeds at the scheduled time.

### BACKGROUND

The present disclosure relates to the field of data communications in general and more particularly, to computer systems that match tutor(s) with student(s) for virtual classes. A “virtual class,” as used herein, refers to a class that is conducted without the student and tutor physically being in a shared space for direct interaction, and includes but is not limited to on-line class.

Communication systems (networks) are commonly employed to provide voice and data communications to users.

As the global communication industry continues to advance, other technologies are being integrated within these communication systems in order to provide value-added services. Recent governmental mandates, e.g., the shelter-at-home instructions during the COVID-19 outbreak in early 2020, make it imperative that students can continue learning by connecting on-line with a remote tutor. One technology being considered to facilitate remote teaching is an on-line classroom that provides a video and audio connection between the student and the tutor and a virtual whiteboard. The advantages of this on-line classroom are that the student can continue to learn and does not have to be in the same location or even time-zone as the tutor.

### SUMMARY

A method and a system for matching a student with a tutor for a virtual class are presented. Candidate tutors for the virtual class are identified in real-time based on a student's preferences and desired class times. The desired class time may be “now.” Once a match is made the virtual class proceeds at the scheduled time.

In another aspect, the inventive concept pertains to a computer-implemented method for scheduling a virtual class. The method entails receiving from a student, via a communication network, a class request and student criteria and receiving from tutors, also via a communication network, tutor information. In response to the class request, a list of tutor candidates is automatically identified by comparing the student criteria with the tutor information. A tutor selection from the list of tutor candidates is received from the student, and the virtual class is scheduled and launched at a scheduled time. The virtual class is shared by the student and a tutor.

In yet another aspect, the inventive concept pertains to one or more non-transitory computer-readable media collectively storing instructions that, when executed, cause one or more computers to perform a method of scheduling a virtual class. The instructions include instructions to receive a class request and student criteria from a student, the class request including a start time; instructions to receive and store tutor criteria from a plurality of tutors, the tutor criteria including tutor's available times; generating a list of tutors based whether the start time coincides with tutor's available times; receiving a tutor selection from the student, out of the list of tutors; and launching the virtual class shared by the student and a selected tutor of the plurality of tutors at the start time.

### BRIEF DESCRIPTION OF THE DRAWINGS

FIG. 1 is schematic block diagram illustrating virtual class user interface;

FIG. 2 is a schematic block diagram illustrating the components of a class matching system according to some embodiments of the present disclosure;

FIG. 3 is a block diagram of a data processing system implementing a class matching server according to some embodiments of the present disclosure;

FIG. 4 is a detailed block diagram of a data processing system implementing a class matching server according to some embodiments of the present disclosure; and

FIG. 5 is a flow chart illustrating operations for matching a student with a tutor for a class according to some embodiments of the present disclosure.

### DETAILED DESCRIPTION

The inventive concept will now be described more fully hereinafter with reference to the accompanying drawings, in which embodiments of the concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout.

As will be appreciated by one of skill in the art, the present disclosure may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present disclosure may take the form of a computer program product on a computer usable storage medium having computer-usable program code embodied in the medium. Any suitable computer readable medium may be used including hard disks, CDROMs, optical storage devices, a transmission media such as those supporting the Internet or an intranet, or magnetic storage devices.

Computer program code for carrying out operations of the present disclosure may be written in an object-oriented programming language, such as JavaScript, Java or C++. However, the computer program code for carrying out operations of the present disclosure may also be written in conventional procedural programming languages, such as the “C” programming language or assembly language. The program code may execute entirely on the user's computer, partly on the user's computer, as a stand-alone software package, partly on the user's computer and partly on a remote computer, or entirely on the remote computer. In the latter scenario, the remote computer may be connected to the user's computer through a local area network (LAN) or a wide area network (WAN).

The inventive concept is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

Embodiments of the inventive concept will now be described with respect to the figures. Embodiments of the inventive concept provide methods, systems and/or non-transitory computer-readable media for matching a student with a tutor for a virtual class.

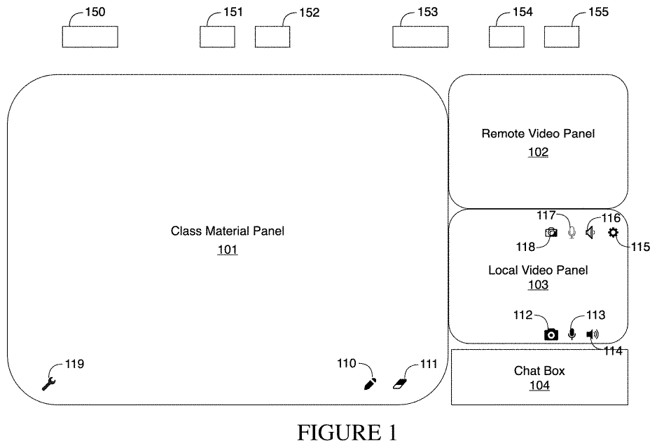

FIG. 1 depicts a virtual class user interface for a student and a tutor. As shown in FIG. 1, the virtual class user interface includes three main sections. The Class Material section 101 displays the teaching material that the tutor uses to teach the class to the student. The Class Material section 101 contains buttons to control the whiteboard feature; for example, the Pencil 110 allows the local participant to draw on top of the Class Material, and the Eraser 111 allows the local participant to erase the drawing on top of the Class Material. The Remote Video section 102 displays the video of the remote participant; in the case of the student the tutor will be displayed, in the case of the tutor the student will be displayed. The Local Video section 103 displays the video of the local participant; in the case of the student, the student will be displayed, in the case of the tutor, the tutor will be displayed. The virtual classroom screen also has a Chat Box 104 which the student and tutor can use to type messages to each other. The Local Video panel 103 contains some buttons to control the local audio and video settings 112, 113, 114, 115, 116, 117 and 118.

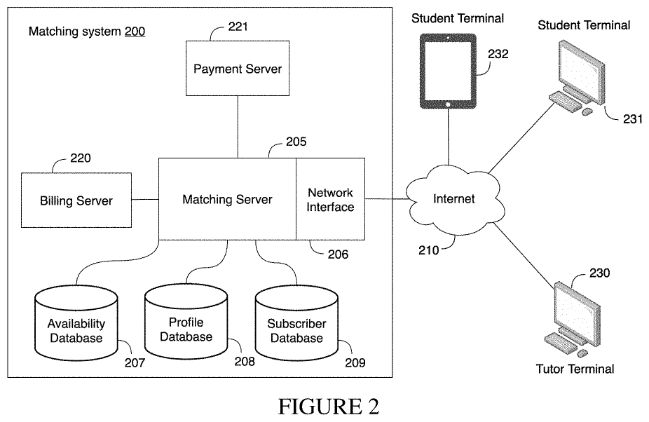

Referring to FIG. 2, a hardware and software environment for tutor matching system 200 according to an embodiment of the present disclosure will be described. As shown in FIG. 2, a Matching Server 205 is coupled through a Network Interface 206 to a network 210, such as an Internet network. The Matching Server 205 is further operatively coupled to a Profile Database 207, an Availability Database 208 and a Subscriber Database 209. The Matching Server 205 is configured to identify a candidate tutor(s) for a class requested by a student based on the current ability and availability of candidate tutor(s). The Subscriber Database 209 stores information related to subscribed users, who may be identified as students, tutors or both.

The Availability Database 207 contains additional information in various embodiments of the present disclosure, such as availability information for the designated tutors stating times and dates on which they are available for providing tutor services responsive to student requests for a class. Any subscriber may update or change the Availability Database 207 to reflect his/her own schedule change.

The Profile Database 208 contains additional information in various embodiments of the present disclosure, such as minimum education levels for particular students and/or tutors and language ability for particular students and/or tutors. Thus, a Matching Server 205 may be configured to identify a candidate tutor based on a variety of information including, but not limited to, the start time of a class, the duration of a class, the current availability of the tutor, an associated ability of the student and/or ability information for the tutor. “Current availability,” as used herein, refers to whether the tutor is available at the time an impromptu class request is received from a student. In some embodiments, “current availability” refers to whether the tutor is available within a short predefined time period (e.g., five minutes) of the time an impromptu class request is received.

The Network Interface 206, as shown in FIG. 2, couples to the Internet 210. The Tutor Terminal 230 is used by the tutor to log on to the Matching Server 205 and set their availability for classes. As such, the Network Interface 206 provides an information interface configured to receive current availability and availability information associated with a candidate tutor. Various such information is stored in the Availability Database 207 and Profile Database 208.

The Network Interface 206 is further configured to receive a class request from a student and to provide the student a list of one or more candidate tutors. The request for a class may come from a variety of different sources, such as from the Student Terminal 231 over the Internet 210. Similarly, a student may use the Student Terminal 232 and may connect over a wireless network to the Internet 210.

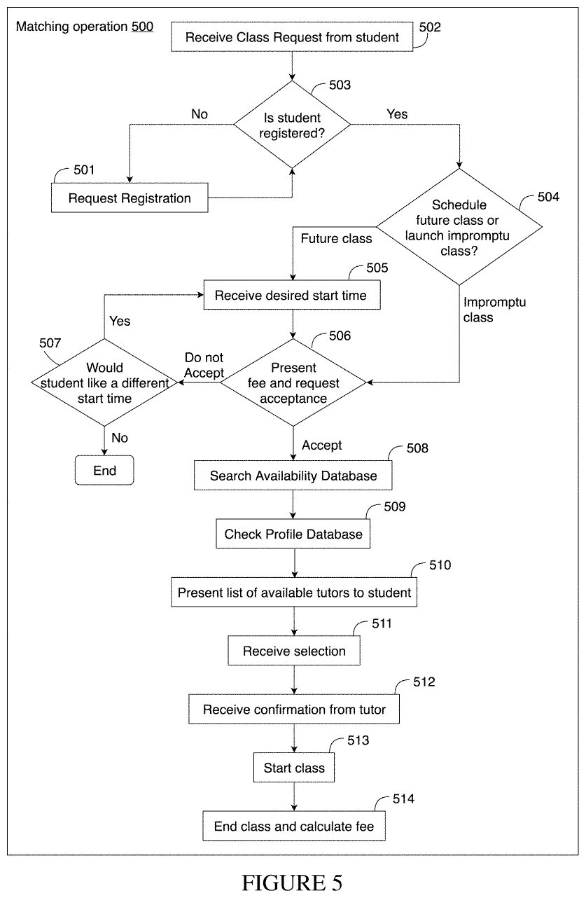

Once a match between a student and a tutor for a class has been made, the Matching Server 205 will launch the virtual class user interface described in FIG. 1. The matching process, which will be described in more detail below in reference to FIG. 5, entails receiving the desired start time and class duration from a student, searching the Availability Database 208 for tutors who are available for the desired class duration starting at the desired class time, then ranking the available tutors according to how closely they fit the student's preferences. In one embodiment, a predefined number of tutors (e.g., top 5) are presented in a list to the student, in the order of how closely they match the student's preferences. Depending on the user interface, the student may be able to click on the name or photo of each tutor on the list to find out more details about each tutor's background. When the student makes a selection, a notice is sent immediately to the tutor asking to accept the class request. Upon the tutor's acceptance of the request, the virtual class user interface, such as the one depicted in FIG. 1, automatically launches on the student terminal and the tutor terminal.

As will be understood by those having skill in the art, the Internet network 210 may include a plurality of separate linked physical communication networks, which, using a protocol, such as the Internet protocol (IP), may appear to be a single seamless communications network to user application programs. In addition, the Network Interface 206 may be a plurality of different interfaces coupled to different network types including wired and wireless networks. The Matching Server 205 may be a variety of different server types. The Student Terminal 231 may also be directly coupled to the Matching Server 205 rather than connected thereto over the Internet 210. Similarly, the Subscriber Database 209, the Profile Database 208 and the Availability Database 207 may be accessed by the Matching Server 205 over the Internet 210 rather than being directly connected to the Matching Server 205.

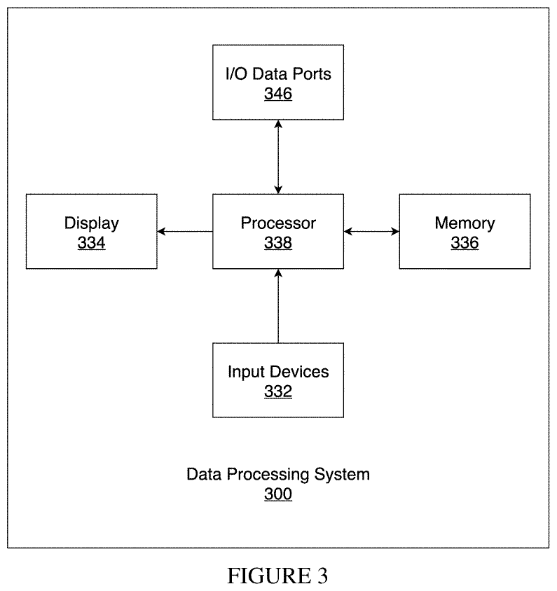

FIG. 3 illustrates an exemplary embodiment of a data processing system 300 suitable for use in accordance with embodiments of the inventive concept. The data processing system 300 may be used as the matching server 205, the student terminal 231/232, and/or the tutor terminal 230. The data processing system 300 typically includes input device(s) 332 such as a keyboard, mouse or keypad, a display 334, and a memory 336 that communicate with a processor 338. The data processing system 330 may further include an I/O data port(s) 346 that also communicates with the processor 338. The I/O data ports 346 can be used to transfer information between the data processing system 330 and another computer system or a network, such as the network 210 of FIG. 2. These components may be conventional components, such as those used in many conventional data processing systems, which may be configured to operate as described herein.

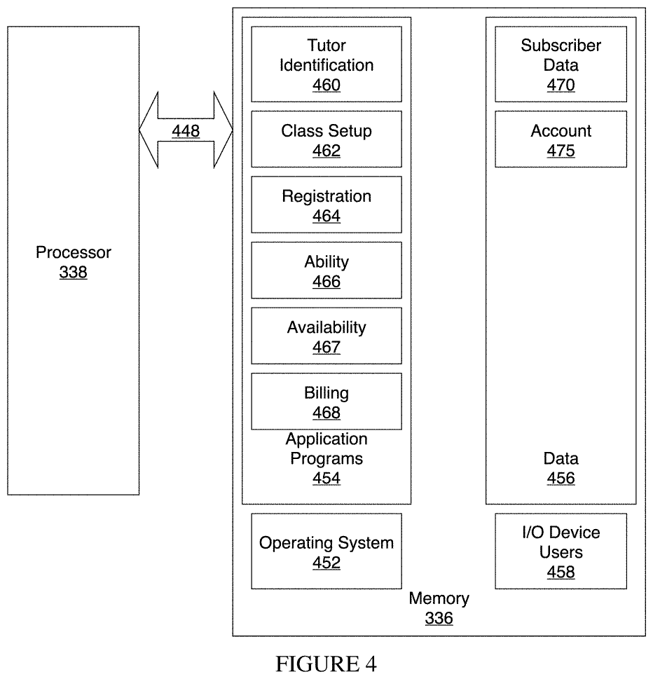

FIG. 4 is a block diagram of a data processing (computer) system that further illustrates systems, methods, and computer program products in accordance with embodiments of the inventive system. The processor 338 communicates with the memory 336 via an address/data bus 448. The processor 338 can be any commercially available or custom microprocessor. The memory 336 is representative of the overall hierarchy of memory devices containing the software and data used to implement the functionality of the data processing system 300. The memory 336 can include, but is not limited to, the following types of devices: cache, ROM, PROM, EPROM, EEPROM, flash memory, SRAM, and DRAM.

As shown in FIG. 4, the memory 336 may include several categories of software and data used in the data processing system 300: the operating system 452; the application programs 454; the input/output (I/O) device users 458; and the data 456. As will be appreciated by those of skill in the art, the operating system 452 may be any operating system suitable for use with a data processing system, such as Windows from Microsoft Corporation, Unix or Linux. The I/O device users 458 typically include software routines accessed through the operating system 452 by the application programs 454 to communicate with devices such as the I/O data port(s) 346 and certain memory 336 components. The application programs 454 are illustrative of the programs that implement the various features of the data processing system 300 and preferably include at least one application that supports operations according to embodiments of the present disclosure. Finally, the data 456 represents the static and dynamic data used by the application programs 454, the operating system 452, the I/O device users 458, and other software programs that may reside in the memory 336.

As is further seen in FIG. 4, the application programs 454 may include a Tutor Identification Module 460, a Class Setup module 462, a Registration module 464, an Ability module 466, an Availability module 467 and/or a Billing module 468. The Tutor Identification module 460 is configured to identify one or more tutors as candidate tutor(s) based on, for example, a determined start time of a student, the current availability and the associated ability of the plurality of tutor(s). The Class Setup module 462, in various embodiments of the present disclosure, is configured to provide a student an identification of a candidate tutor or tutors, for example, by establishing a communication connection between the student and the candidate tutor.

The Availability module 467 is configured to receive a request from a student for a tutor for a class. The Ability module 467 may be configured to receive such a request specific to a particular class and/or as an initial registration procedure for subscribers as tutors and/or students in the Subscriber Database 209. Such initial registration information may include a selection of registration as a student and/or tutor, a normal start time, a default end time, an availability time for a tutor and/or a normal associated duration for the tutor.

In particular embodiments, the Ability module 466 is configured to obtain current ability information from a database that may be used by the Tutor Identification module 460 in identifying an appropriate candidate tutor for a class. Various embodiments of the present disclosure further include a Billing module 468 that is configured to transfer payment amounts from an account of a student to an account of the candidate tutor for an agreed class.

The Data portion 456 of memory 336, as shown in the embodiments of FIG. 4, may include various types of data, such as the Subscriber Data 470 and the Account Data 475. The Subscriber Data 470, as discussed above, may include information received from the Registration module 464. Similarly, the Account Data 475 may include separate accounts associated with each of the subscribers and may be used by the Billing module 468 in arranging payment for different classes. Alternatively, where accounts for both the payee and the payor of a particular transaction are not available, the Billing module 468 and the Accounts Data 475 may be used to generate the necessary billing information and credit any subsequent payments.

While the present invention is illustrated, for example, with reference to the Tutor Identification module 460 being an application program in FIG. 4, as will be appreciated by those of skill in the art, other configurations may also be utilized while still benefiting from the teachings of the inventive concept. For example, the Tutor Identification module 460 may also be incorporated into the Operating System 452 or other such logical divisions of the Data Processing System 300. Thus, the present invention should not be construed as limited to the configuration of FIG. 4 but is intended to encompass any configuration capable of carrying out the operations described herein.

Furthermore, while each of the Tutor Identification module 460, the Class Setup module 462, the Registration module 464, the Ability module 466, the Availability module 467 and the Billing module 468 are illustrated in a single data processing system, as will be appreciated by those of skill in the art, such functionality may be distributed across one or more data processing systems. For example, the functionality of the Tutor Identification module 460 may be provided on one or more data processing (computer) systems that are separate from the data processing system that provides the functionality of the Class Setup module 462. Thus, the present disclosure should not be construed as limited to the configuration illustrated in FIGS. 3-4, and may be provided by other arrangements and/or division of function between data processing systems.

FIG. 5 depicts a matching operation 500 for matching a student to a tutor for a class. The registration process 501, whereby the students and the tutors register with the Subscriber Database 209, is a preliminary step for the matching operation 500. Hence, upon receiving a class request from a student (Block 502) the matching server 205 checks to see if the contacting student is registered (Block 503). If the contacting student is not registered, registration is required (Block 501) to proceed with the matching operation 500. Once registration is confirmed, Block 504 asks the student if she is interested in scheduling a class for the future or starting an impromptu class. An “impromptu class,” as used herein, refers to an on-demand class that is set to start within a short predefined period (e.g., no more than 5 minutes) from the time of class request. Once registration is done, the matching operation 500 starting with a student's class request happens in “real-time,” or almost instantaneously.

If the student indicates an interest in scheduling a future class, the student's desired start time and duration are received (Block 505). Regardless of whether the student chooses the impromptu option or the scheduled option, the matching server 205 presents a fee for the requested class and requests acceptance of the fee (Block 506) prior to performing the matching. The fee structure/formula is stored somewhere in the matching system 200 (e.g., the billing server 220) and readily retrieved by the matching server 205. In one example, the fee may be $X for a minimum duration of N minutes, and an additional $Y per time increment (e.g., per minute, per 5 minutes) exceeding the minimum duration. The student may get a “discount” or free minutes of tutoring if a certain length of class time is met, either in a single session or cumulatively. The inventive concept is not limited to any particular fee structure.

If the presented fee structure is not accepted, the student is asked if she would like to change a variable that leads to a different fee. For example, the student might accept a new teacher with fewer years of teaching experience or choose a different start time that is less popular. In the example depicted in FIG. 5, the student is asked if she would like to change her start time (Block 507). If her answer is “no,” that is the end of the matching process 500. If she chooses a different start time (or changes another variable in her preference), a new fee is presented based on the changed start time (Block 506). Upon receiving the acceptance of the fee, the matching server 205 searches the Availability database to find registered tutors whose availability coincides with the start time and duration that are desired by the student (Block 508). Where there are tutors with different fees, the searching may also be limited to tutors who are within the fee that was agreed in Block 506.

In some embodiments, for the tutors who are available, the Profile Database 207 is checked to search for tutors who match the preference criteria requested by the student during registration (Block 509). These preference criteria may be proficient languages, educational level, teaching experience, etc. The available tutors may be ranked according to how closely they match the student's preference criteria. Then, a list of top X (e.g., top 5) tutors who are available at the requested time is generated and presented to the student in the order of preference match (Block 510), e.g. from the tutors that most closely match the student's specified preferences to the ones that match the fewest.

If, in Block 504, the student indicates an interest in an impromptu class, the Availability Database 208 is searched for any tutors indicated to be available now or within a few minutes from now (Block 508). Those tutors are identified, and checked against the requesting student's preferences stored in the Profile Database 207 (Block 509). A list of tutors who are available immediately is generated and presented to the student in the order of preference match (Block 510), e.g. from the tutors that most closely match the student's specified preferences to the ones that match the fewest. If student preference indicates a preference for familiar tutors, tutors that the student has worked with before or a tutor who works with the student on a regular basis who is available at the requested class time may be prioritized on the list. In some embodiments, the list may show a preset number of (e.g., top X) closest preference matches.

The student may make a selection from the list generated in block 510 (Block 511). In some embodiments, the user interface for the selection may allow the student to click on a tutor's listing (e.g., the tutor's photo or name) to see more details about the tutor (e.g., how much teaching experience the tutor has) to aid in the selection process. Upon receiving the selection from a student, the tutor matching system 200 requests confirmation to the selected tutor (Block 512), for example in the form of a pop-up screen on the tutor's device with a question such as “Accept 30-minute class for Jun. 5, 2020 at 5 pm?” in the case of future scheduling or “Accept impromptu class for 30 minute duration?” If the tutor does not accept within a predefined time (e.g., 10 minutes for the scheduled class and 2 minutes for the impromptu class), the student is asked to select another tutor from the list. This process continues until the tutor selected by the student accepts the class request (Block 512). If the class request was for an impromptu class request, the virtual class interface depicted in FIG. 1 launches on both the student terminal and the tutor terminal, and class starts (Block 513). If the class request is for a future time, the virtual class room screen of FIG. 1 launches at the scheduled class time (Block 513).

Where class duration is tied to the fee, the billing server 220 tracks the amount of class time and calculates the fee at the conclusion of class. The fee calculation is made according to a predefined formula (e.g., $X base fee for minimum duration+$Y for every extra time increment). An advantage of the matching system 200 having control over the virtual class user interface is that whether the class is actually happening may be monitored. Pictures of the virtual class user interface may be taken at random times while the class is in progress to make sure both the student and the tutor are present, or a click request icon may pop up periodically to both the student's and tutor's interfaces so that both parties would need to click on the pop-up icon to confirm that the class is still happening. Although the inventive concept is not limited to any specific type of monitoring measure, acceptance of the monitoring measure is received from both students and tutors at registration.

In Block 509, the Matching Server 205 retrieves the student's skill level and the tutor's preferences from the Profile Database 208. The preferences from the student may be received at the time the tutor request is submitted (Block 502) or may be included as part of the initial registration of the student as a subscriber. Preferences may include, for example, a certain ability (e.g., speaks English, has a Bachelor's Degree, has at least 3 years of teaching/tutoring experience, has experience working with 3^{rd} graders).

In some embodiments, after the tutor accepts the class (Bock 510), a communication connection is established between the student and the candidate tutor. A connection may be provided that includes identification of the individual or may be initially established in a manner that protects privacy of the respective student and tutor with subsequent personal information being provided only after an agreement is reached for the class. The agreement may be about what to cover in the class, how the class should be conducted, the payment, etc. The connection may be a voice and/or video connection, email and/or text messaging or other electronic communication media, which may allow the use of the class matching server 205 to control privacy concerns of the individuals involved.

At the conclusion of the class, the Billing Server 220 calculates the fee (Block 514). The Matching Server 205 may connect to the Billing Server 220 and transfer payment from the account of the student to the account associated with the selected candidate tutor through Payment Server 221. In particular embodiments of the present disclosure, the Matching Server 205 may further provide additional information to the student and/or tutor, such as calculating the price for the class and estimating the duration.

As described above, it will be understood that tutor matching systems according to various embodiments of the present inventive concept may increase the usability of tutor arrangements by making such systems more convenient and efficient through automated identification of candidate tutors based on current availability information. Such automated matching of candidate tutors may encourage use of the system by providing for matching of classes between tutors and students in a timely fashion. The service may be beneficially implemented in light of the increased usage of wireless devices. Security concerns in various embodiments may be addressed by providing a subscriber access to the service with controlled access and verification of personal information stored in a secure database. In addition, such information may be repeatedly utilized so that, when a student logs on the class matching service, a variety of the personal information items would already be available for use in determining current availability of suitable tutors that match the desired preferences for the requesting student subscriber.

By automatically initiating a connection between the subscribing student and the candidate tutor, the Matching Server may further facilitate and reduce the burden of establishing a class connection between students and tutors. Furthermore, in various embodiments of the present disclosure, automatic billing arrangements are provided that may be based on actual cash transfers between subscribers or structured in a manner that allocates a fixed value amount to each registered subscriber, which they may then maintain by acting both as a tutor and student. Thus, the automatic registration of tutors and current availability linked with availability of requesting students, further facilitated by automated connection of students and candidate tutors to arrange details of a class and, in some embodiments, even automated processing of the payment for the class between accounts of a student and tutor, may facilitate more effective utilization of such a class matching service over current methods for establishing tutoring classes.

The flowcharts, flow diagrams and block diagrams of FIGS. 1 through 5 illustrate the architecture, functionality, and operation of possible implementations of systems, methods and computer program products for matching a student with a tutor for a class according to embodiments of the present invention. In this regard, each block in the flow charts or block diagrams may represent a module, segment, or portion of code, which comprises one or more executable instructions for implementing the specified logical act(s). It should also be noted that, in some alternative implementations, the acts noted in the blocks may occur out of the order noted in the figures. For example, two blocks shown in succession may, in fact, be executed substantially concurrently, or the blocks may sometimes be executed in the reverse order, depending upon the functionality involved.

In the drawings and specification, there have been disclosed typical illustrative embodiments of the inventive concept and, although specific terms are employed, they are used in a generic and descriptive sense only and not for purposes of limitation, the scope of the inventive concept being set forth in the following claims.

What is claimed is:

1. A computer-implemented method for scheduling a virtual class, comprising:
receiving from a student, via a communication network, a class request and student criteria;
receiving from tutor candidates, via a communication network, tutor information;
in response to the class request, automatically identifying a list of tutor candidates by comparing the student criteria with the tutor information;
receiving from the student a tutor selection from the list of tutor candidates; and
scheduling the virtual class and launching the virtual class shared by the student and the tutor at a scheduled time.

2. The computer-implemented method of claim 1, wherein student criteria comprises one or more of the following:
start time;
duration of class;
skill level of student; and
requirements for tutor.

3. The computer-implemented method of claim 2, wherein the start time is in less than five minutes from a time at which a class request is received from the student.

4. The computer-implemented method of claim 1, wherein the tutor criteria comprises one or more of the following:
availability window;
acceptable skill level of student;
education level of the tutor;
teaching experience of the tutor; and
language skills of the tutor.

5. The computer-implemented method of claim 1, wherein launching the virtual class comprises establishing a communication connection between the student and the tutor.

6. The computer-implemented method of claim 5, wherein launching the virtual class further comprises transmitting one or more of live audio and live video data between the student and the tutor.

7. The computer-implemented method of claim 6, wherein launching the virtual class further comprises establishing a text messaging connection between the student and the tutor.

8. The computer-implemented method of claim 1 further comprising:
showing the list of tutor candidates to the student; and
receiving a selection of the tutor from the student.

9. The computer-implemented method of claim 8, further comprising:
requesting approval from the tutor to schedule a virtual class at a scheduled time with the student; and
launching a virtual classroom screen interfacing the student and the tutor at the scheduled time.

10. The computer-implemented method of claim 8, further comprising generating the list of tutor candidates by identifying tutors who are available at the start time indicated in the student criteria, and ranking the identified tutors according to how closely they match the student criteria other than the start time.

11. The computer-implemented method of claim 1 wherein the student criteria comprises a skill level, and wherein the identifying of the list of tutor candidates comprises
searching tutor candidates' preferences stored in a database, the tutor candidates' preferences indicating acceptable skill level of students; and
checking if each tutor candidates' preferences includes the skill level in the student criteria as acceptable.

12. The computer-implemented method of claim 1 wherein the identifying a list of tutor candidates comprises:
accessing a database to retrieve registered tutors' available times; and
determining which of the registered tutors are available at the time specified in the student criteria.

13. The computer-implemented method of claim 1 further comprising processing payment from the student to the tutor.

14. The method of claim 1 wherein identifying the list of tutor candidates comprises:
determining which tutors, according to their tutor criteria, are available at the start time specified in the student criteria for a duration indicated in the student criteria; and
determining which of the available tutors satisfy other parameters in the student criteria.

15. The computer-implemented method of claim 1, further comprising:
storing the student information and the tutor information in a database;
updating the student information and the tutor information in the database in response to receiving changes; and
retrieving the updated student information and the tutor information from the database for the comparing.

16. The method of claim 1 further comprising registering a subscriber as both a student and a tutor.

17. The method of claim 1 further comprising:
tracking a length of the virtual class after the launching; and
calculating a fee using the length of the virtual class and a predefined fee formula.

18. One or more non-transitory computer-readable media collectively storing instructions that, when executed, cause one or more computers to perform a method of scheduling a virtual class, the instructions comprising:
instructions to receive a class request and student criteria from a student, the class request including a start time;
instructions to receive and store tutor criteria from a plurality of tutors, the tutor criteria including tutor's available times;
generating a list of tutors based whether the start time coincides with tutor's available times;
receiving a tutor selection from the student, out of the list of tutors; and
launching the virtual class shared by the student and a selected tutor of the plurality of tutors at the start time.

19. The non-transitory computer-readable media of claim 18, wherein the start time is less than five minutes from the time when the class request is received.

20. The non-transitory computer-readable media of claim 18, further comprising:
comparing the tutor criteria from the plurality of tutors to student criteria; and
ranking the plurality of tutors based on how closely each one of the plurality of tutors fulfills the student criteria.
